(19) United States
(12) Patent Application Publication
(10) Pub. No.: US 2009/0071208 A1
(43) Pub. Date: Mar. 19, 2009

(54) Lock structure with fingerprint recognition function

(75) Inventor: Jang-Chang Wang, Taipei City (TW)

Correspondence Address: BACON & THOMAS, PLLC, 625 SLATERS LANE, FOURTH FLOOR, ALEXANDRIA, VA, 22314-1176, US

(73) Assignee: WIDE MERIT CO., LTD., Taipei City (TW)

(21) Appl. No.: 11/898,820

(22) Filed: Sep. 17, 2007

(51) Int. Cl. E05B 65/00

(52) U.S. Cl. 70/277

(57) ABSTRACT

A lock structure includes a lock installed in the two hinged box chambers of a storage container and having a link controllable to move a locking plate between the locking position and the unlocking position, and a fingerprint reader mounted on the outside of one box chamber corresponding to the lock for allowing a user to move the link through a slide thereof to unlock the lock when the link is released from the constraint after the user's fingerprint has been recognized by the fingerprint reader.

### BACKGROUND OF THE INVENTION

1. Field of the Invention

The present invention relates to locks and more particularly, to a lock structure with fingerprint recognition function, which allows the user to unlock the lock after the user's fingerprint has been recognized.

2. Description of the Related Art

When traveling for business, people usually will carry a suitcase, luggage or suitable storage container means to keep important documents, securities, paper money, jewelry, precious metals, and/or may other important and precious personal items. A storage container for this purpose generally has a lock for locking the container in the closed condition. The use of such a container may encounter the following problems:

1. An evil person can open the lock (either a combination lock or pin tumbler lock) easily with a simple tool.

2. The lock is not tailor made for a particular person. Any person who gets the key of the pin tumbler lock or the combination code of the combination lock can open the storage container.

3. If the user does not have the key in hand or forgets the combination code, the user will be unable to open the storage container.

### SUMMARY OF THE INVENTION

The present invention has been accomplished under the circumstances in view. It is therefore the main object of the present invention to provide a lock structure for storage container, which allows the user to unlock the lock after the user's fingerprint has been recognized. To achieve this and other objects of the present invention, the lock structure comprises a lock and a fingerprint reader. The lock comprises a housing affixed to a top box chamber of the storage container, a control circuit assembly mounted in the housing, a strike plate affixed to a bottom box chamber of the storage container corresponding to the housing, the strike plate having a plurality of hook holes, a locking plate mounted in the housing, the locking plate having two swivel hooks extending out of the housing for hooking in the hook holes of the strike plate to lock the housing to the strike plate, a link mounted in the housing and coupled to the locking plate and operable to move the locking plate between a locking position where the swivel hooks are respectively forced into engagement with the hook holes of the strike plate and an unlocking position where the swivel hooks are disengaged from the hook holes of the strike plate, the link having a push plate at one end thereof, a movable stop plate mounted inside the housing, the movable stop plate having an oblique stop flange stopped against the push plate of the link, a swivel connector pivotally mounted in the housing, a driver mounted inside the housing controllable by said control circuit assembly to move the swivel connector between a first position where the swivel connector is engaged with the movable stop plate to stop the link from movement and a second position where the swivel connector is disengaged from the movable stop plate for allowing movement of the movable stop plate with the link. The fingerprint reader is mounted on the outside of the top box chamber of the storage container, comprising a fingerprint sensor adapted to detect the fingerprint of a specific person, an electrical connector electrically connected to the control circuit assembly of the lock for outputting a driving signal to the control circuit assembly for causing the driver to move the swivel connector to the second position to unlock the movable stop plate and the link when the fingerprint sensor detected the fingerprint of the specific person, and a slide coupled to the link for moving the link when the movable stop plate is unlocked from the swivel connector.

### BRIEF DESCRIPTION OF THE DRAWINGS

FIG. 1 is an elevational view of a lock structure according to the present invention.

FIG. 2 is an exploded view of the lock structure according to the present invention.

FIG. 3 is an exploded view of the lock for the lock structure according to the present invention.

FIG. 4 is a perspective view of the lock for the lock structure according to the present invention.

FIG. 5 is a schematic top view of the lock for the lock structure according to the present invention before unlocking operation.

FIG. 6 is a schematic side view of the lock for the lock structure according to the present invention before unlocking operation.

FIG. 7 is a schematic bottom view of the lock for the lock structure according to the present invention during unlocking operation.

FIG. 8 is a schematic side view of the lock for the lock structure according to the present invention during unlocking operation.

FIG. 9 is a schematic side view showing the unlocked status of the lock of the lock structure according to the present invention.

FIG. 10 is a schematic side view of the lock for the lock structure according to the present invention before locking operation.

FIG. 11 is a schematic side view showing the locked status of the lock for the lock structure according to the present invention.

### DETAILED DESCRIPTION OF THE PREFERRED EMBODIMENT

Referring to FIGS. 14, a lock structure in accordance with the present invention is shown comprised of a fingerprint reader 1, a lock 2 and a storage container 3.

The fingerprint reader 1 comprises a holder frame 11, a touch type fingerprint sensor 12 mounted on the holder frame 11 for fingerprint recognition, and a slide 13 slidably mounted in the holder frame 11 at one side of the fingerprint sensor 12. The fingerprint sensor 12 has an electrical connector 121 at its bottom side. The slide 13 has a bottom retaining hole 131.

The lock 2 comprises a housing 21. The housing 21 is formed of a bottom cover shell 211 and a top cover shell 212. The bottom cover shell 211 and the top cover shell 212 are fastened together, defining an accommodation chamber 22 that accommodates a control circuit assembly 221. A driver 222 is electrically connected to the control circuit assembly 221, having a reciprocating rod 2221 connected to a swivel connector 223 that is pivotally mounted on a locating frame 23 and adapted to move a movable stop plate 231. The movable stop plate 231 has an oblique stop flange 232 stopped against a horizontal push plate 241 of a link 24. The link 24 has a vertical push rod 242 extending to the outside of the top cover shell 212, and a plurality of bearing flanges 243 horizontally outwardly extending from the bottom edge of its one side and attached to a bottom edge 251 of a locking plate 25. The locking plate 25 has a stop flange 252 downwardly extending from the bottom edge 251, two locating notches 253 formed on the bottom edge 251 at two sides of the stop flange 252 and adapted to receive the bearing flanges 243 of the link 24, and two swivel hooks 254 respectively provided at the two distal ends. The swivel hooks 254 each have an oblique coupling slot 2541 respectively coupled to a respective locating bolt 2542 at the top cover shell 212 to limit movement of the swivel hooks 254 relative to the locking plate 25 to a predetermined angle between a locking position where the swivel hooks 254 are respectively hooked in a respective hook hole 261 on a strike plate 26 outside the housing 21 and an unlocking position where the swivel hooks 254 are disengaged from the hook holes 261 of the strike plate 26.

The storage container 3 according to this embodiment is a suitcase having a top box member 31 and a bottom box member 32. The top box member 31 and the bottom box member 32 are hinged together, defining a storage chamber 33.

During installation, the fingerprint reader 1 is mounted on the outside of the top box member 31, the lock 2 is mounted on the inside of the top box member 31 corresponding to the fingerprint reader 1, and the strike plate 26 is affixed to the inside of the bottom box member 32 corresponding to the lock 2. When installed, the push rod 242 of the link 24 of the lock 2 extends out of the top box member 31 and engaged into the bottom retaining hole 131 of the slide 13 of the fingerprint reader 1, and the swivel hooks 254 of the locking plate 25 are respectively hooked in the hook holes 261 of the strike plate 26, locking the storage container 3.

Further, the aforesaid driver 222 can be an air cylinder, hydraulic cylinder, motor drive, electromagnetic valve or any of a variety of driving sources capable of moving the reciprocating rod 2221.

The driver 222 is mounted in a holder space 234 inside the locating frame 23. The locating frame 23 has a sliding way 235 that limits the moving direction of the movable stop plate 231. The reciprocating rod 2221 of the driver 222 has a coupling hole 2222 coupled to a pin 224 of the swivel connector 223. The swivel connector 223 has a locating notch 225 engaged with a protruding portion 233 of the movable stop plate 231, holding the movable stop plate 231 against a spring arm 236 of the locating frame 23. When starting the driver 222 to move the reciprocating rod 2221 in one direction, the swivel connector 223 is biased relative to the locating frame 23 to disengage the locating notch 225 from the protruding portion 233 of the movable stop plate 231, allowing free movement of the movable stop plate 231 along the sliding way 235 of the locating frame 23. On the contrary, when moving the reciprocating rod 2221 in the reversed direction, the swivel connector 223 is returned to force the locating notch 225 into engagement with the protruding portion 233 of the movable stop plate 231, prohibiting movement of the movable stop plate 231 relative to the locating frame 23.

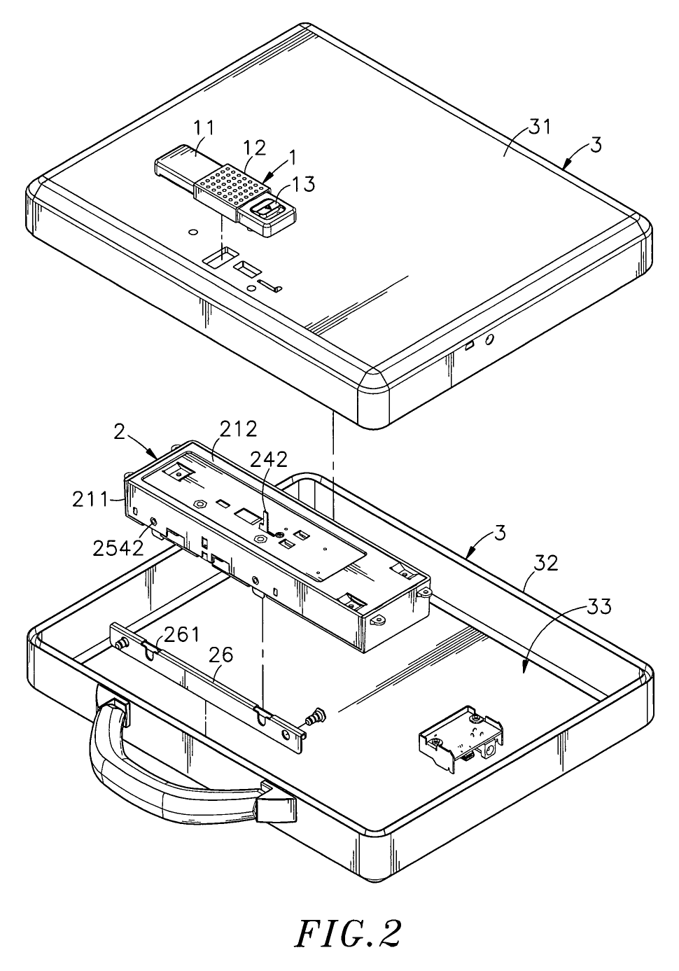

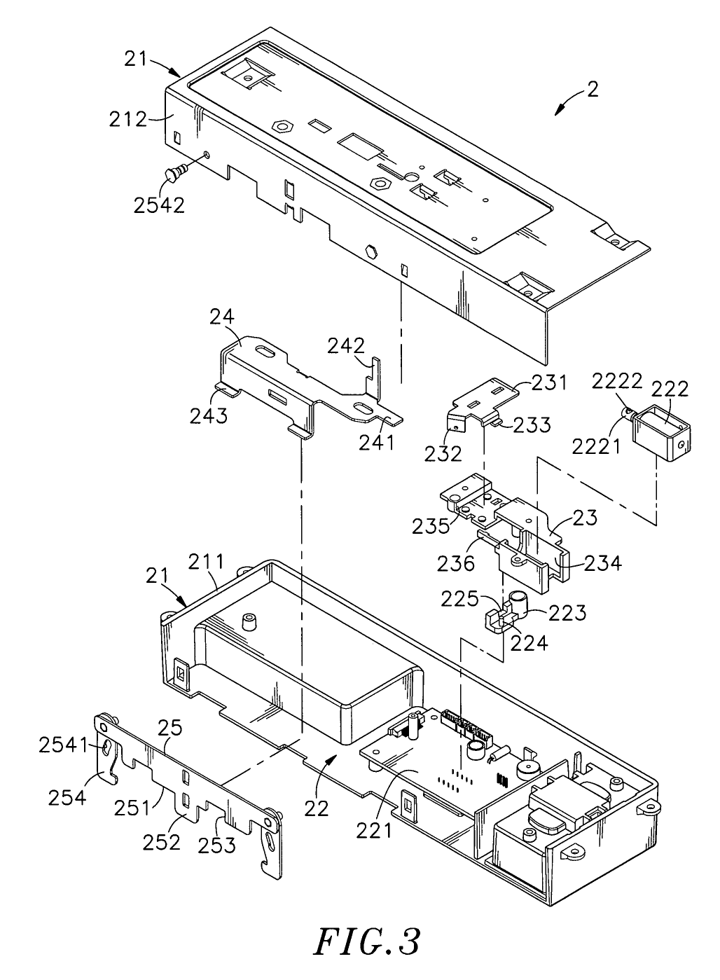

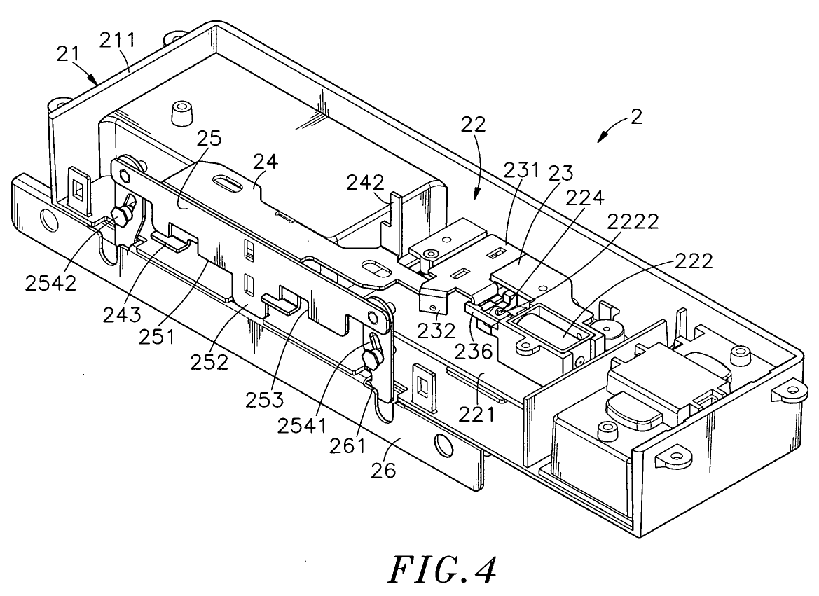

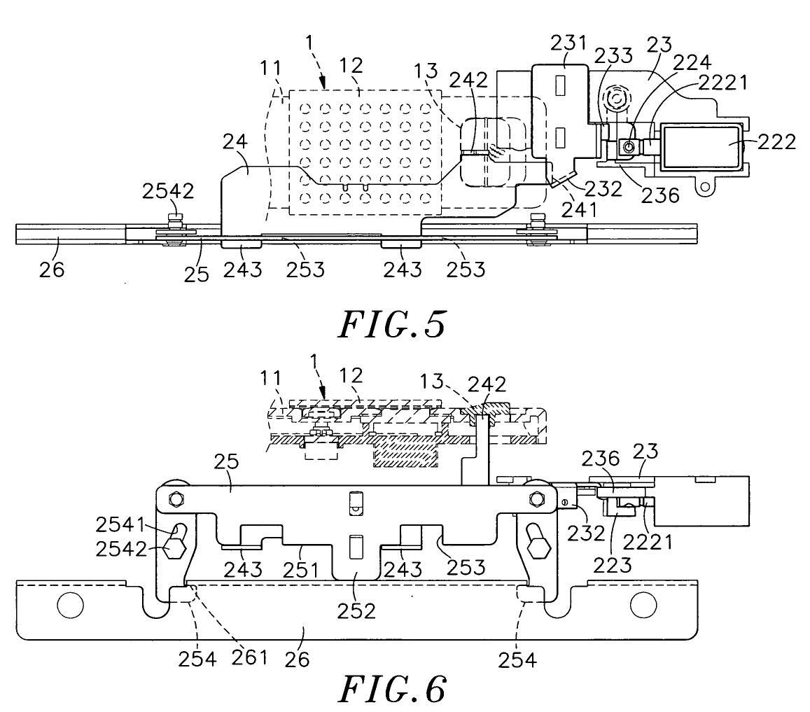

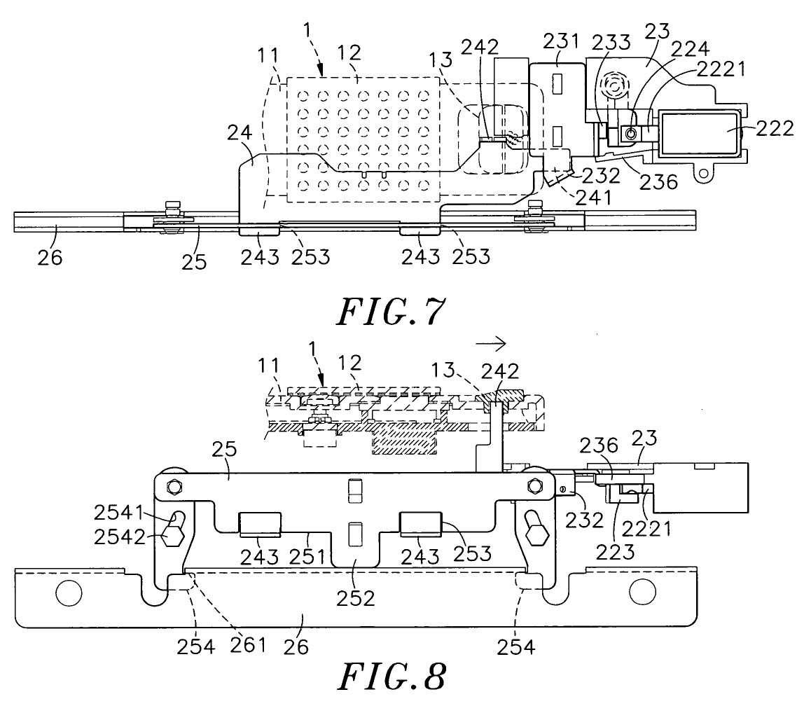

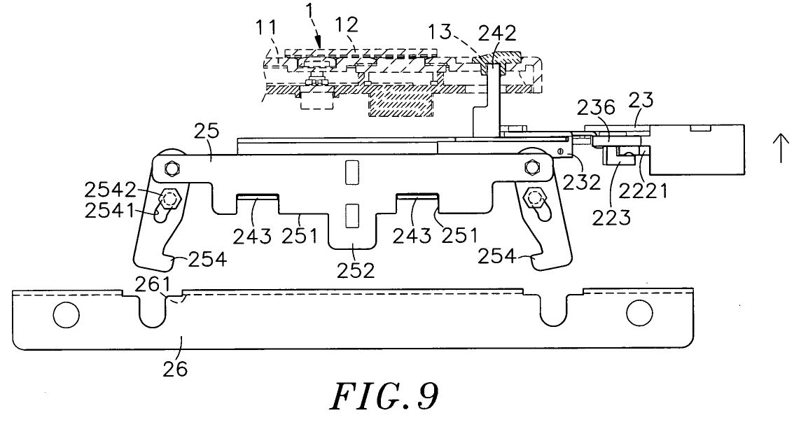

Referring to FIGS. 5˜9, when unlock the lock structure, a user must press the finger on the fingerprint sensor 12 of the fingerprint reader 1 for recognition. The fingerprint sensor 12 sends a detected signal through the electrical connector 121 to the control circuit assembly 221 of the lock 2, causing the control circuit assembly 221 to drive the driver 222 in moving the reciprocating rod 2221, and therefore the swivel connector 223 is biased relative to the locating frame 23 to disengage the locating notch 225 from the protruding portion 233 of the movable stop plate 231, allowing free movement of the movable stop plate 231 along the sliding way 235 of the locating frame 23. The user can then push the slide 13 to move the push rod 242 of the link 24, forcing the bearing flanges 243 into engagement with the retaining notches 253 of the locking plate 25, and therefore the swivel hooks 254 are turned about the respective locating bolts 2542 and disengaged from the associating hook holes 261 of the strike plate 26. At this time, the housing 21 is released from the constraint of the strike plate 26, and the user can then open the top box member 31 from the bottom box member 32 (see FIGS. 2 and 3).

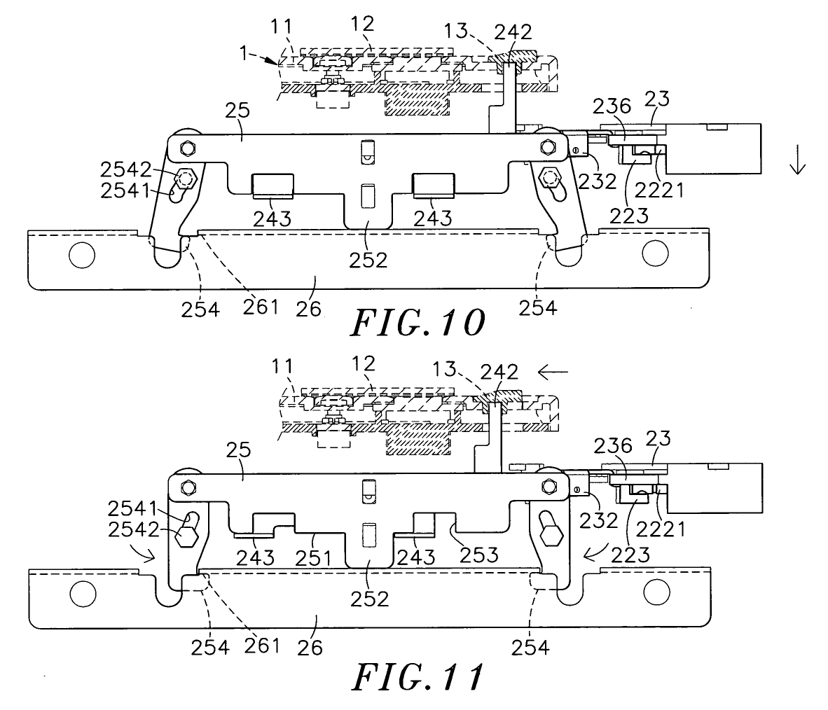

Referring to FIG. 10˜11, on the contrary, when the user closed the top box member 31 on the bottom box member 32, the bottom stop flange 252 of the locking plate 25 is stopped against the top side of the strike plate 26, and therefore the retaining notches 253 of the locking plate 25 are disengaged from the bearing flanges 243 of the link 24, and the bearing flanges 243 are moved transversely with the link 24 and stopped against the bottom edge 251 of the locking plate 25 again to further lift the locking plate 25. At this time, the swivel hooks 254 are turned about the associating locating bolts 2542 and forced into engagement with the associating the hook holes 261 of the strike plate 26 again, and the movable stop plate 231 is returned to its former position to force the protruding portion 233 into engagement with the locating notch 225 of the swivel connector 223 again, and therefore the lock structure is locked.

In general, the invention provides a lock structure comprised of a fingerprint reader 1 and a lock 2, and installed in a storage container 3 formed of hinged top box member 31 and bottom box member 32. The lock 2 is openable after recognition of the user's fingerprint by the fingerprint reader 1.

In actual practice, the lock structure of the present invention has the following features and advantages:

1. The fingerprint reader 1 controls the lock 2 to lock/unlock the storage container 3, ensuring high security.

2. The fingerprint reader 1 can be set subject to the fingerprint of a specific user, prohibiting any other person to unlock the lock structure and enhancing the security of the lock structure.

3. By means of fingerprint recognition to control locking/unlocking of the lock structure, the user needs not to carry a key or memorize a code number.

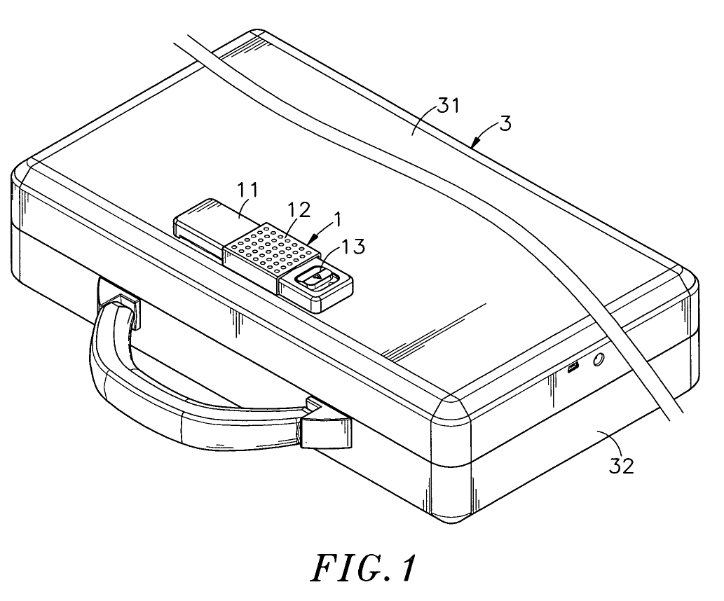

A prototype of lock structure has been constructed with the features of FIGS. 1˜11. The lock structure functions smoothly to provide all the features discussed earlier.

Although a particular embodiment of the invention has been described in detail for purposes of illustration, various modifications and enhancements may be made without departing from the spirit and scope of the invention. Accordingly, the invention is not to be limited except as by the appended claims

What the invention claimed is:

1. A lock structure comprising a fingerprint reader and a lock and installed in two hinged box chambers of a storage container for locking said hinged box chambers in a closed condition, wherein
said lock comprises a housing affixed to one box chamber of said storage container, a control circuit assembly mounted in said housing, a strike plate affixed to the other box chamber of said storage container corresponding to said housing, said strike plate having a plurality of hook holes, a locking plate mounted in said housing, said locking plate having two swivel hooks extending out of said housing for hooking in said hook holes of said strike plate to lock said housing to said strike plate, a link mounted in said housing and coupled to said locking plate and operable to move said locking plate between a locking position where said swivel hooks are respectively forced into engagement with said hook holes of said strike plate and an unlocking position where said swivel hooks are disengaged from said hook holes of said strike plate, said link having a push plate at one end thereof, a movable stop plate mounted inside said housing, said movable stop plate having an oblique stop flange stopped against the push plate of said link, a swivel connector pivotally mounted in said housing, a driver mounted inside said housing controllable by said control circuit assembly to move said swivel connector between a first position where said swivel connector is engaged with said movable stop plate to stop said link from movement and a second position where said swivel connector is disengaged from said movable stop plate for allowing movement of said movable stop plate with said link;
said fingerprint reader is mounted on the outside of the box chamber of said storage container in which said housing of said lock is installed, said fingerprint reader comprising a fingerprint sensor adapted to detect a fingerprint of a specific person, an electrical connector electrically connected to said control circuit assembly of said lock for outputting a driving signal to said control circuit assembly for causing said driver to move said swivel connector to said second position to unlock said movable stop plate and said link when said fingerprint sensor detected the fingerprint of said specific person, and a slide coupled to said link for moving said link when said movable stop plate is unlocked from said swivel connector.

2. The lock structure as claimed in claim 1, wherein said slide has a bottom retaining hole; said link has a vertical push rod coupled to the bottom retaining hole of said slide.

3. The lock structure as claimed in claim 1, wherein said driver is a motor drive.

4. The lock structure as claimed in claim 1, wherein said driver is an air cylinder.

5. The lock structure as claimed in claim 1, wherein said driver is a hydraulic cylinder.

6. The lock structure as claimed in claim 1, wherein said driver is an electromagnetic valve.

7. The lock structure as claimed in claim 1, wherein said lock further comprises a locating frame fixedly mounted inside said housing to accommodate said driver and to support said movable stop plate.

8. The lock structure as claimed in claim 7, wherein said locating frame comprises a holder space, which accommodates said driver, and a sliding way, which supports said movable stop plate and guides movement of said movable stop plate thereon.

9. The lock structure as claimed in claim 7, wherein said swivel connector is pivotally mounted on a bottom side of said locating frame.

10. The lock structure as claimed in claim 1, wherein said swivel hooks of said locking plate each have an oblique coupling slot respectively coupled to a respective locating bolt at said housing.

11. The lock structure as claimed in claim 1, wherein said driver is controllable by said control circuit assembly to move a reciprocating rod thereof, said reciprocating rod having a coupling hole; said swivel connector has a pin coupled to said coupling hole of said driver.
